(19) United States
(12) Patent Application Publication
(10) Pub. No.: US 2026/0230216 A1
(43) Pub. Date: Aug. 6, 2026

(54) BASEBAND SIGNAL GENERATION WITH ORTHOGONAL COVER CODES

(71) Applicant: QUALCOMM Incorporated, San Diego, CA (US)

(72) Inventors: Syed Hashim Ali SHAH, Littleton, MA (US); Ayan SENGUPTA, Mountain View, CA (US); Alberto RICO ALVARINO, San Diego, CA (US)

(21) Appl. No.: 19/422,310

(22) Filed: Dec. 16, 2025

Related U.S. Application Data
(60) Provisional application No. 63/754,415, filed on Feb. 5, 2025.

(51) Int. Cl. H04L 1/00; H04W 72/21

(52) U.S. Cl. CPC H04L 1/0009; H04L 1/0003; H04W 72/21

(57) ABSTRACT

Certain aspects of the present disclosure provide techniques for baseband signal generation with orthogonal cover codes (OCC). An example method, performed at a user equipment (UE), generally includes obtaining first signaling indicating an orthogonal cover code (OCC) configuration and a modulation scheme, generating a signal using the OCC configuration and the modulation scheme, wherein the signal is generated with a phase rotation based on at least one of the OCC configuration or the modulation scheme, and outputting the signal for transmission via a physical channel.

### CROSS-REFERENCE TO RELATED APPLICATION

This application is a Non-Provisional application and claims the benefit of U.S. Provisional Application No. 63/754,415 filed Feb. 5, 2025, which is hereby incorporated by reference in its entirety for all applicable purposes.

### FIELD OF THE DISCLOSURE

Aspects of the present disclosure relate to wireless communications, and more particularly, to techniques for baseband signal generation.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication. The method includes obtaining first signaling indicating an orthogonal cover code (OCC) configuration and a modulation scheme; generating a signal using the OCC configuration and the modulation scheme, wherein the signal is generated with a phase rotation based on at least one of the OCC configuration or the modulation scheme; and outputting the signal for transmission via a physical channel.

Another aspect provides a method for wireless communication. The method includes outputting first signaling indicating orthogonal cover code (OCC) configurations and modulation schemes; and obtaining, via physical channels, signals generated using the OCC configurations and the modulation schemes, with a phase rotation applied to at least one of the signals based on at least one of an OCC configuration of the OCC configurations or a modulation scheme of the modulation schemes.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example scenario in which transmissions from multiple UEs are multiplexed using orthogonal cover codes (OCCs).

FIG. 6 depicts example baseband signal generation using OCCs.

FIG. 7 depicts an example matrix for baseband signal generation using OCCs and a same modulation scheme.

FIG. 8 depicts example baseband signal generation using OCCs and different modulation schemes.

FIG. 9 depicts an example matrix for baseband signal generation using OCCs different modulation schemes.

FIG. 10 depicts a call flow diagram illustrating techniques for baseband signal generation, in accordance with certain aspects of the present disclosure.

FIG. 11 depicts an example of a phase rotation scheme for baseband signal generation with OCCs, in accordance with certain aspects of the present disclosure.

FIG. 12 depicts example baseband signal generation using OCCs and a same phase rotation scheme, in accordance with certain aspects of the present disclosure.

FIG. 13 depicts an example matrix illustrating baseband signal generation using OCCs and a same phase rotation scheme, in accordance with certain aspects of the present disclosure.

FIG. 14 depicts example baseband signal generation using OCCs and a phase rotation scheme, in accordance with certain aspects of the present disclosure.

FIG. 15 depicts an example matrix illustrating baseband signal generation using OCCs and a phase rotation scheme, in accordance with certain aspects of the present disclosure.

FIG. 16 depicts a method for wireless communications.

FIG. 17 depicts a method for wireless communications.

FIG. 18 depicts aspects of an example communications device.

### DETAILED DESCRIPTION

Aspects of the present disclosure provide apparatuses, methods, processing systems, and computer-readable mediums for baseband signal generation with orthogonal cover codes (OCCs).

Baseband signals generated in accordance with the techniques described herein may be used for physical uplink shared channel (PUSCH) transmissions from multiplexed user equipments (UEs) that share time and frequency resources. The techniques described herein may be particularly beneficial in narrowband (NB) operation, where UEs are multiplexed on a relatively small amount of frequency resources. For example, the techniques may be used for NB PUSCH (NPUSCH) transmissions in NB Internet of Things (NB-IOT) deployments.

Various multiple access schemes exist for multiplexing multiple wireless nodes, such as user equipments (UEs), hence, increasing capacity. In this context, increased capacity refers to supporting more UEs on a same amount of time and frequency resources.

Unfortunately, multiplexing multiple UEs creates interference at a network entity (e.g., a base station/gNB). One approach to mitigate such interference is to utilize orthogonal cover codes (OCCs). An orthogonal cover code refers to a specific sequence of values used to transmit repetitions from different UEs in an orthogonal manner. By assigning different OCCs to different UEs, transmissions from the UEs do not interfere with each other, even when sharing the same frequency band. Effectively OCCs provide “cover” to prevent signal collisions from different UEs. OCCs can increase a duration of transmitted signals by a multiplexing factor of M, where M represents an upper bound quantity of UEs that can be multiplexed (e.g., or in many cases, a number of multiplexed UEs). For example, the number of multiplexed UEs may be up to M. In other words, the number of multiplexed UEs may be less than M, but resources are wasted in such a scenario.

In some cases, OCCs may be used for baseband generation for physical uplink shared channel (PUSCH) transmissions. For example, OCC may be used for narrowband PUSCH (NPUSCH) transmissions in a non-terrestrial network (NTN). UEs that are multiplexed together for NPUSCH transmissions may use the same or different modulation orders, which could potentially present problems in maintaining orthogonality due to current phase rotation schemes.

UEs using OCC and the same modulation order (e.g., both using binary phase-shift keying (BPSK) or both using quadrature phase-shift keying (BPSK), may be able to maintain orthogonality. However multiplexed UEs that use different modulation schemes (e.g., one using BPSK and the other QPSK) may have issues maintaining orthogonality with baseband signal generation using OCC in the NTN scenario. These issues may be caused because of the phase rotation introduced in the waveform generation to minimize zero crossings in the signal. It is beneficial to minimize zero crossings, because zero crossings may cause high peak to average power ratio (PAPR).

Aspects of the present disclosure provide various baseband signal generation techniques for NPUSCH with OCC. These techniques may allow for flexibility, enabling multiplexing of UEs using different modulation schemes, while maintaining orthogonality.

The techniques proposed herein may help optimize uplink capacity enhancements obtained from OCC for narrow band Internet of Things (NB-IoT) NTN use cases.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

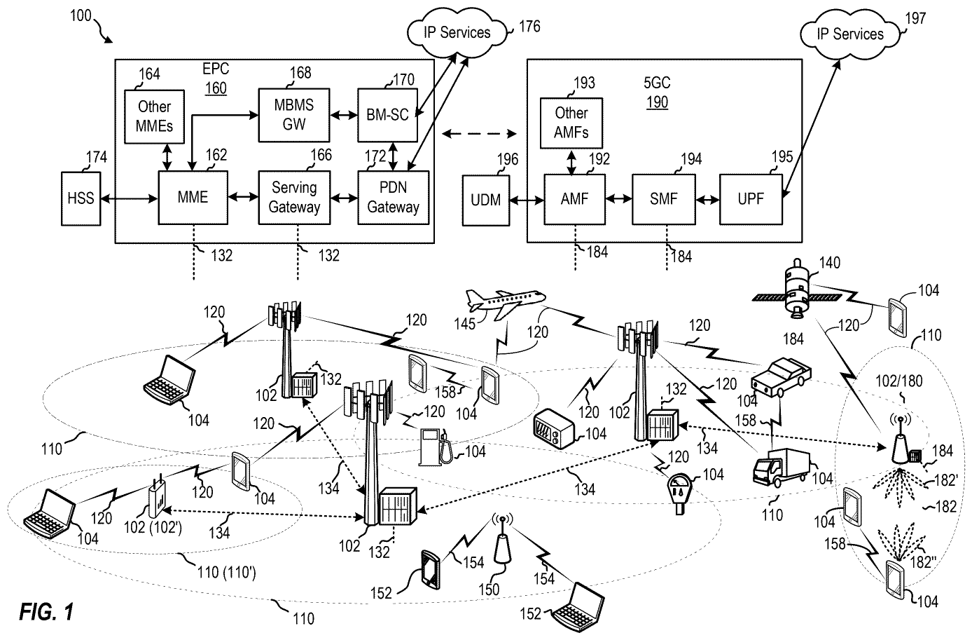

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

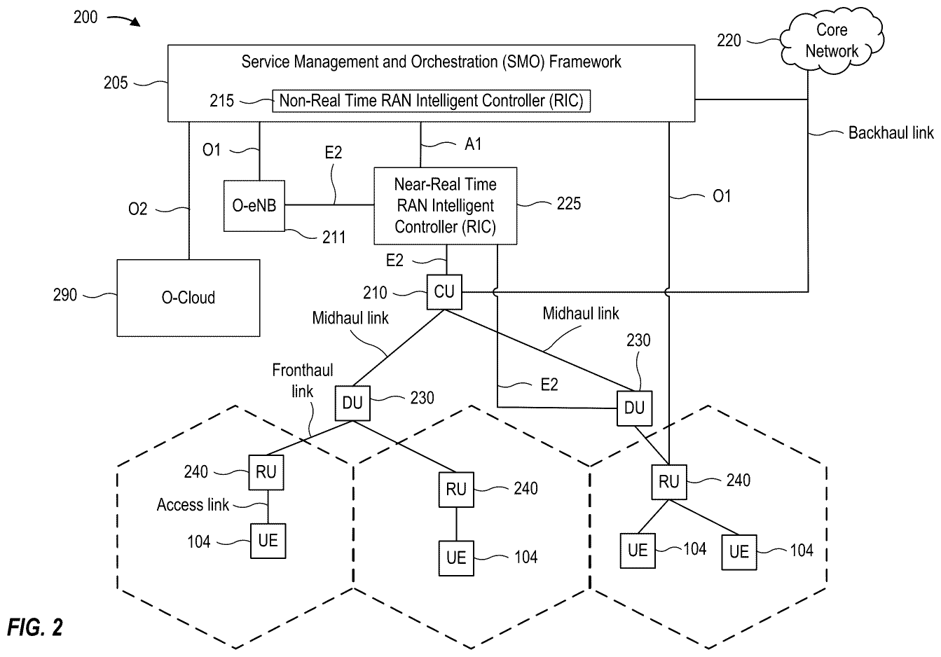

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

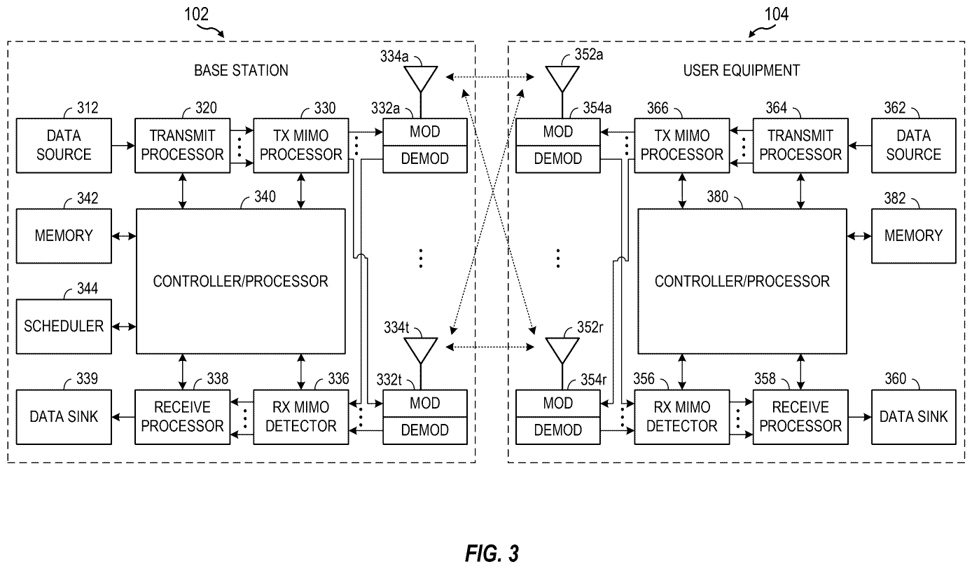

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

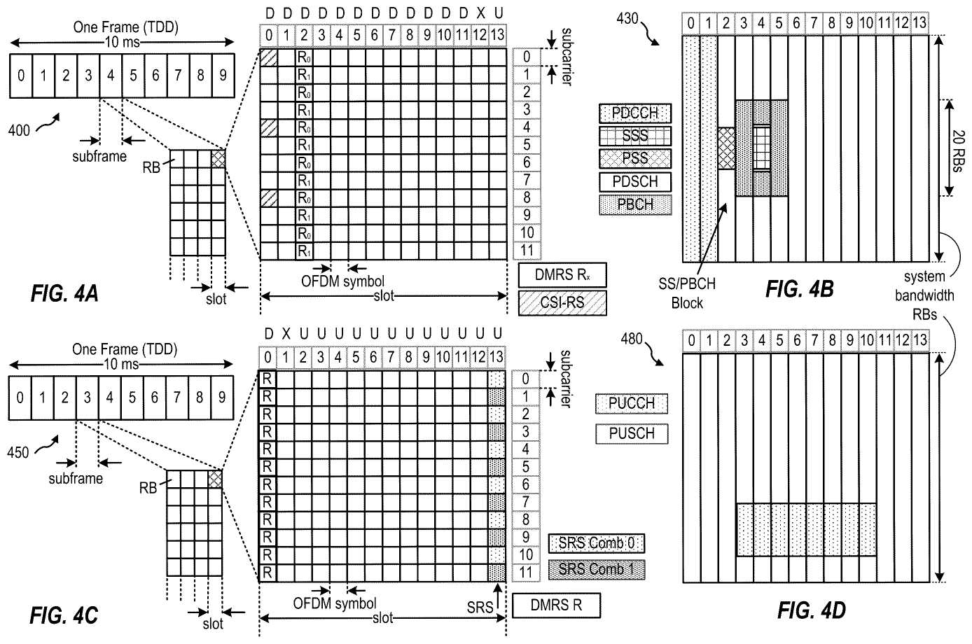

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 s.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

Overview of Baseband Signal Generation with Orthogonal Cover Codes (OCC)

As noted above, the use of orthogonal cover codes (OCCs) is one approach to help mitigate interference between transmissions from UEs multiplexed on a common set of time and frequency resources. By assigning different OCCs to different UEs, transmissions from the UEs do not interfere with each other, as the OCCs effectively prevent signal collisions from different UEs.

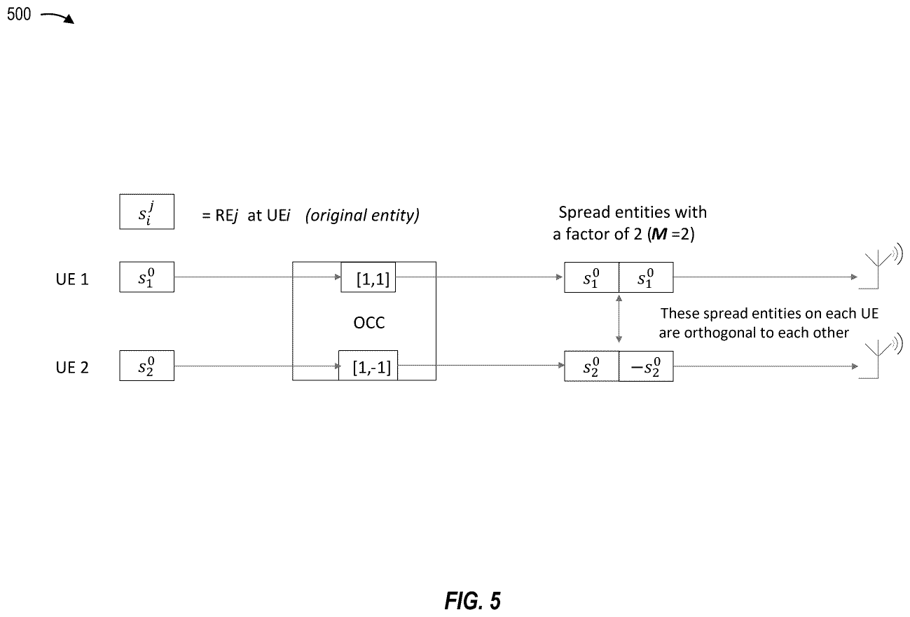

OCCs can increase a duration of transmitted signals by a multiplexing factor of M, where M represents a number of multiplexed UEs. Diagram 500 of FIG. 5 depicts an example of OCC transmissions, for two multiplexed UEs UE1 and UE2 (M=2).

In the context of OCC, entity refers to a unit or component that the OCC code is designed to cover or protect in a systematic way. For example, in symbol-level or slot-level OCC, an entity would be a symbol or slot, respectively.

The example assumes UE1 and UE2 are multiplexed together using OCC with Hadamard codewords:
UE 1 uses OCC codeword [1,1], successively transmitting

$${s}_{1}^{0} and {s}_{1}^{0} ;$$

and
UE 2 uses OCC codeword [1,−1], successively transmitting

$${s}_{2}^{0} and - {s}_{2}^{0} ;$$

and
   Thus, as indicated, each UE spreads entities (e.g., symbols or slots) with a factor of 2. These spread entities on each ULE are orthogonal to each other. In other words, when a receiver is applying the OCC code for UE1 ([1,1]), and the signal from UE2 was transmitted with an orthogonal code ([1,−1]), the signal from UE2 will cancel out

$$( {s}_{2}^{0} - {s}_{2}^{0} = 0 ) .$$

As noted above, OCC may be used for NPUSCH (e.g., for narrowband IoT (NBIoT) NTN and other use cases). As an example, symbol-level OCC may be used for subcarrier spacing (SCS) of 3.75 kHz single subcarrier (SC) NPUSCH transmissions for UEs in connected mode. As another example, slot-level OCC may be used for SCS of 15 kHz single SC NPUSCH transmissions.

UEs using OCC and the same modulation order may be able to maintain orthogonality, even when phase rotation is introduced in the waveform generation to minimize zero crossings in the signal.

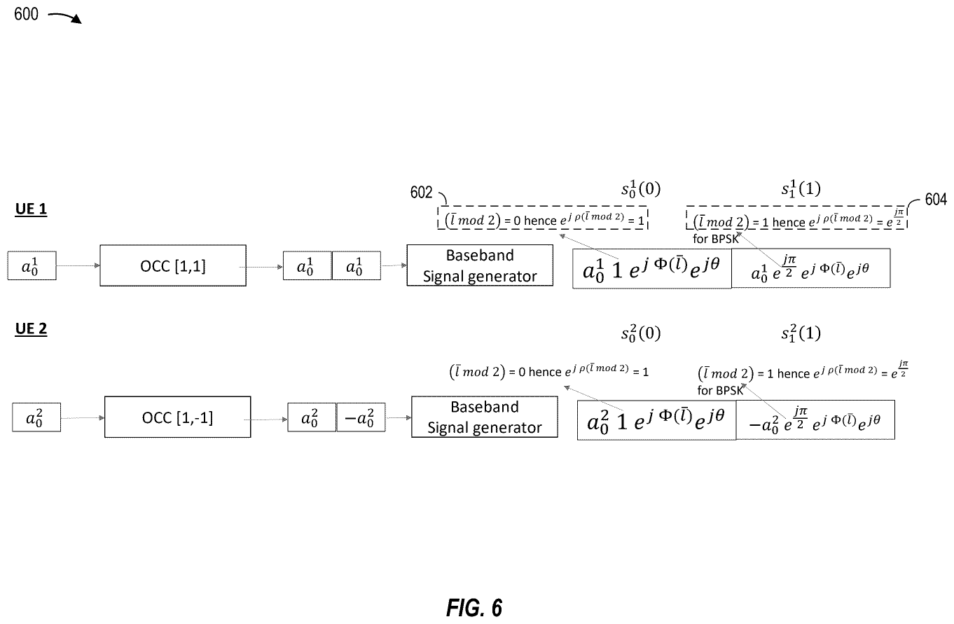

This may be understood by considering diagram 600 shown in FIG. 6, which depicts an example of baseband signal generation with OCC, where the UEs use the modulation orders. In the illustrated example, UE1 and UE2 both use BPSK.

As illustrated, the first element and second element of each UE is the same. As noted at 602 and 604, for both UE1 and UE2:

$$( \overline{l} mod 2 ) = 0 , so {e}^{j ρ ( \overline{l} mod 2 )} = 1 for the first element ; and$$

$$( \overline{l} mod 2 ) = 1 , so {e}^{j ρ ( \overline{l} mod 2 )} = {e}^{\frac{j π}{2}} for the second element .$$

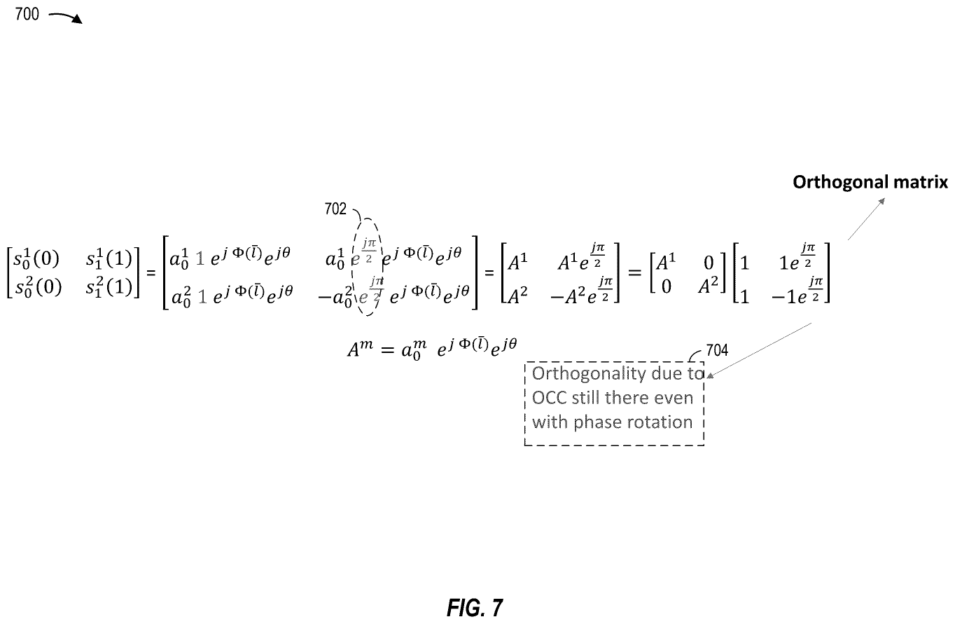

Taking this result, the baseband signals at both UEs can be written as a matrix, as illustrated in diagram 700 of FIG. 7. Because of the same phase rotation factors used by each UE due to both using BPSK,

$${e}^{\frac{j π}{2}} ,$$

as indicated at 702, an orthogonal matrix results. As a result, orthogonality of OCC is maintained, as indicated at 704.

As mentioned before, UEs using OCC and the same modulation order may be able to maintain orthogonality, even when phase rotation is introduced in the waveform generation to minimize zero crossings in the signal.

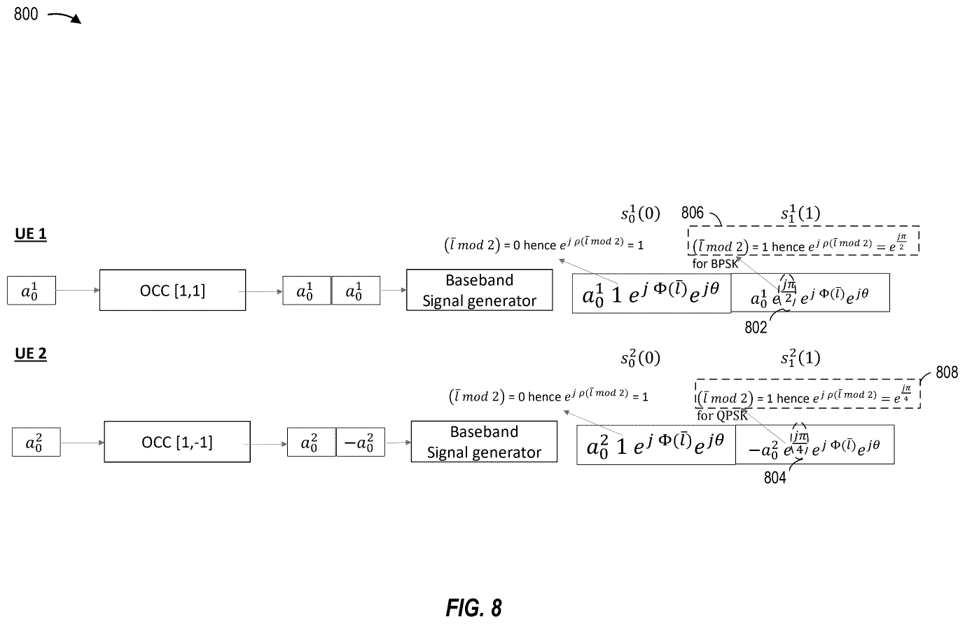

This may be understood by considering diagram 800 shown in FIG. 8, which depicts an example of baseband signal generation with OCC, where the UEs use different modulation orders. In the illustrated example, UE1 uses BPSK and UE2 uses QPSK.

As illustrated, the first element of each is the same as in the example described above, but the second elements are different, as noted at 806 and 808:

$$( \overline{l} mod 2 ) = 1 , so {e}^{j ρ ( \overline{l} mod 2 )} = {e}^{\frac{j π}{2}} for BPSK ; and$$

$$( \overline{l} mod 2 ) = 1 , so {e}^{j ρ ( \overline{l} mod 2 )} = {e}^{\frac{j π}{4}} for QPSK .$$

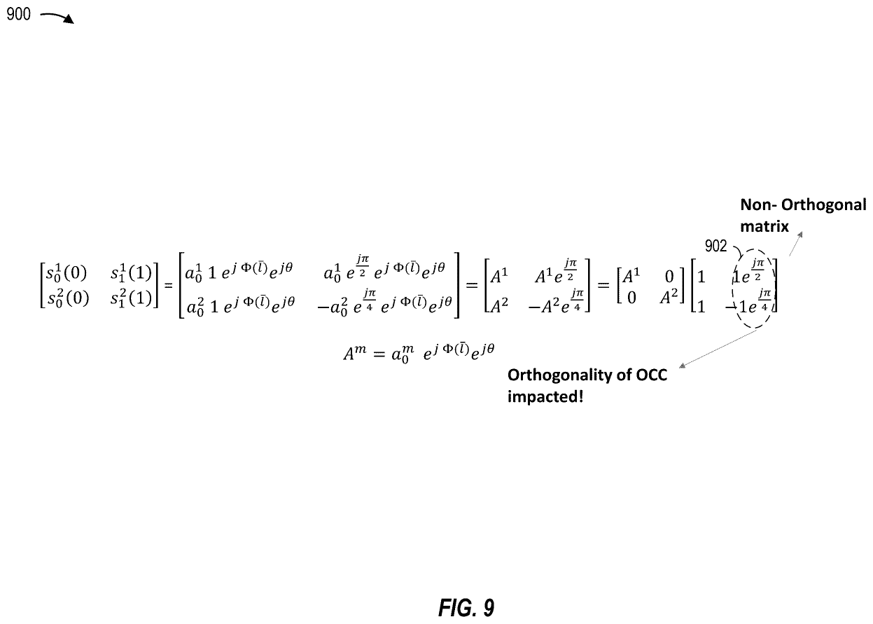

Taking this result, the baseband signals at both UEs can be written as a matrix, as illustrated in diagram 900 of FIG. 9. Because of the different phase rotation factors used for BPSK and QPSK,

$${e}^{\frac{j π}{2}} and {e}^{\frac{j π}{4}} ,$$

as indicated at 904, a non-orthogonal matrix results, and the orthogonality of OCC is adversely impacted. This non-orthogonality may impact the performance of the system, reducing interference cancellation capabilities of OCC, which may result in performance and/or capacity loss.
Aspects Related to Baseband Signal Generation with Orthogonal Cover Codes (OCC)

Aspects of the present disclosure provide various baseband signal generation techniques that may allow for multiplexing of UEs using different modulation orders. Thus, the techniques proposed herein may help optimize uplink capacity enhancements obtained from OCC for various deployment scenarios, such as narrow band Internet of Things (NB-IoT) NTN use cases.

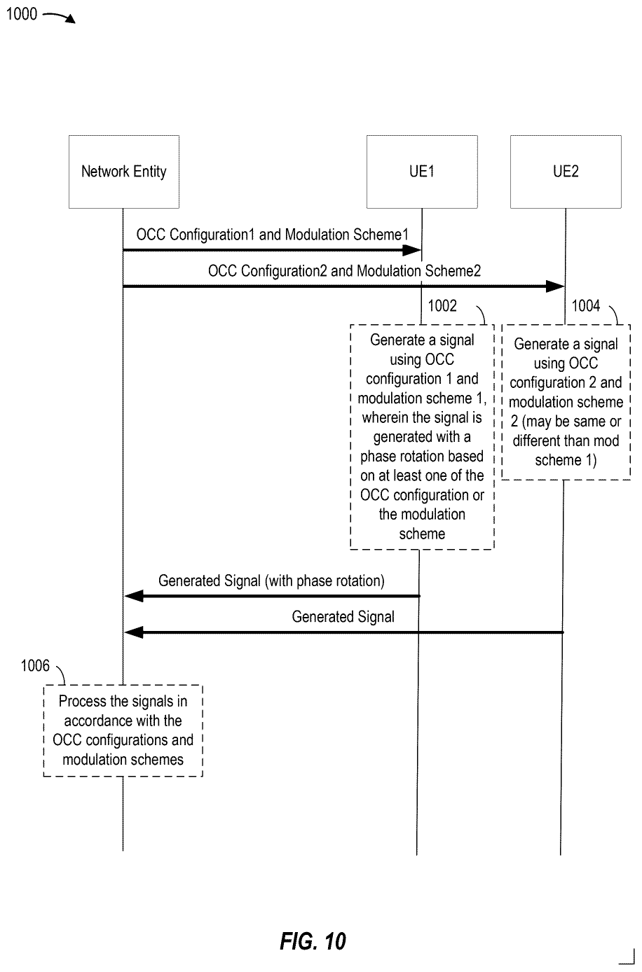

Baseband signal generation techniques proposed herein may be understood with reference to the call flow diagram 1000 of FIG. 10.

In some aspects, the network entity shown in FIG. 10 may be an example of the BS 102 depicted and described with respect to FIGS. 1 and 3 or a disaggregated base station depicted and described with respect to FIG. 2. Similarly, the UEs (e.g., UE1 or UE2) may be examples of UE 104 depicted and described with respect to FIGS. 1 and 3. However, in other aspects, the network entity and/or UEs may be another type of wireless communications device and the network entity may be another type of network entity or network node, such as those described herein.

As illustrated, a wireless node (e.g., a network entity) may configure each UE with an OCC configuration and modulation scheme. Each OCC configuration may indicate a spread factor and an OCC codeword (with each UE assigned a different OCC codeword). The modulation schemes may be the same or different. For example, modulation scheme 1 may be BPSK and modulation scheme 2 may be QPSK.

As illustrated at 1002, UE1 may generate a first signal (e.g., a baseband signal for NPUSCH) using OCC configuration 1 and modulation scheme 1, where the first signal is generated with a phase rotation based on at least one of the OCC configuration or the modulation scheme. Similarly, as illustrated at 1004, UE2 may generate a second signal using the OCC configuration 2 and modulation scheme 2 (e.g., which may be the same or different than modulation scheme 1).

As illustrated at 1006, the network entity may (obtain the first and second signals via a physical channel and) process the signals in accordance with the OCC configurations and modulation schemes. For example, the network entity may demultiplex the first signal using the OCC assigned to UE1 via OCC configuration 1 and may demultiplex the second signal using the OCC assigned to UE2 via OCC configuration 2.

There are various options for how to support OCC in a manner that allows for multiplexing UEs using different modulation orders.

For example, a first option is to make the phase rotation the same for both modulation schemes when OCC is enabled (e.g., for NPUSCH).

As noted above, in current systems, the phase rotation factor ρ based on modulation scheme is defined (e.g., in standard specification) as π/2 for BPSK and π/4 for QPSK. However, if phase rotations are made the same for both modulation schemes, the problem with loss of orthogonality may be removed.

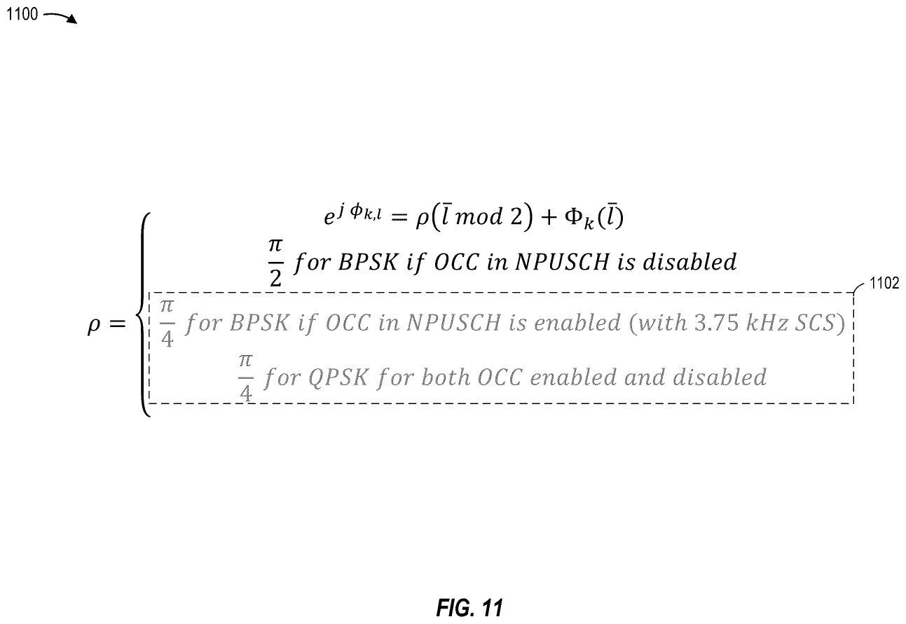

Diagram 1100 of FIG. 11 shows an example rule that may be defined to ensure that phase rotations are made the same for both modulations schemes. As illustrated, the rule may dictate that:

$${e}^{j {ϕ}_{k , l}} = ρ ( \overline{l} mod 2 ) + {Φ}_{k} ( \overline{l} )$$

$$ρ = \{ \begin{matrix}\frac{π}{2} for BPSK if OCC in NPUSCH is disabled \\ \frac{π}{4} for BPSK if OCC in NPUSCH is enabled \\ \frac{π}{4} for QPSK for both OCC enabled and disabled\end{matrix}$$

In other words, in this example as indicated at 1102, the phase rotation factor ρ for BPSK depends on whether or not OCC is enabled. Alternatively, the rule may dictate that:

$${e}^{j {ϕ}_{k , l}} = ρ ( \overline{l} mod 2 ) + {Φ}_{k} ( \overline{l} )$$

$$ρ = \{ \begin{matrix}\frac{π}{2} for BPSK ( for both OCC enabled and disabled ) \\ \frac{π}{2} for QPSK if OCC in NPUSCH is enabled \\ \frac{π}{4} for QPSK if OCC in NPUSCH is disabled\end{matrix}$$

In other words, the rule may dictate that, for BPSK, phase rotation factor ρ is π/2 always. The rule may also dictate that, for QPSK: if OCC is disabled, phase rotation factor ρ is π/4, and if OCC is enabled, phase rotation factor ρ is π/2 (e.g., the same as BPSK). This example rule may be more peak to average power ratio (PAPR) friendly compared to the alternative rule described above.

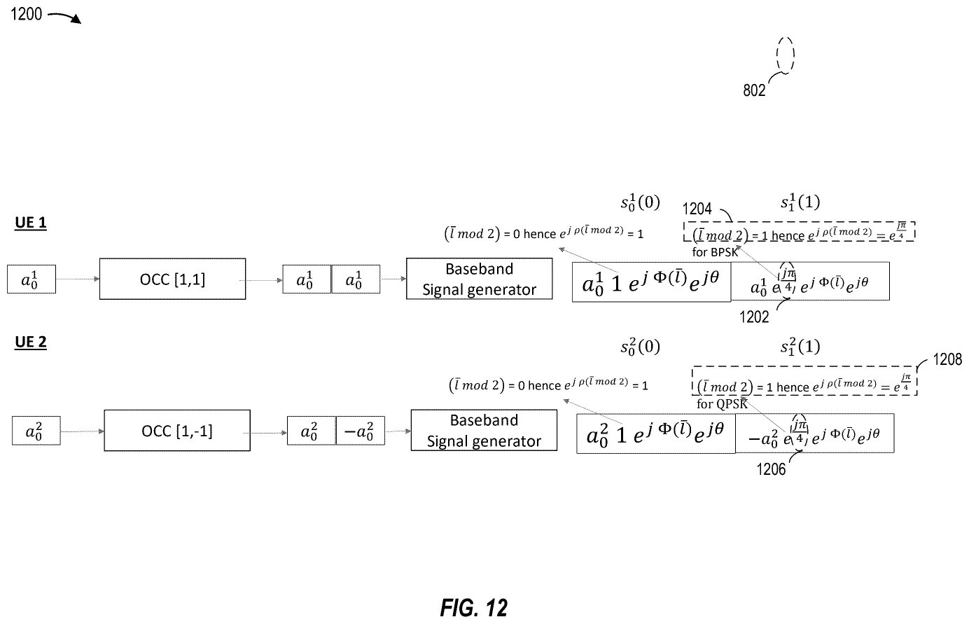

The impact of this approach may be understood by considering diagram 1200 shown in FIG. 12, which depicts an example of baseband signal generation with OCC, where the UEs use different modulation orders, but apply the rule shown above. In the illustrated example, UE1 uses BPSK, and UE2 uses QPSK.

As illustrated, the first element and second element of each UE is the same. As noted at 1202 and 1206, both UEs use a phase rotation factor ρ of π/4, despite using different modulation schemes. Thus, as shown at 1204 and 1208, the second OCC element for both UE1 and UE2 is:

$$( \overline{l} mod 2 ) = 1 , so {e}^{j ρ ( \overline{l} mod 2 )} = {e}^{\frac{j π}{4}} .$$

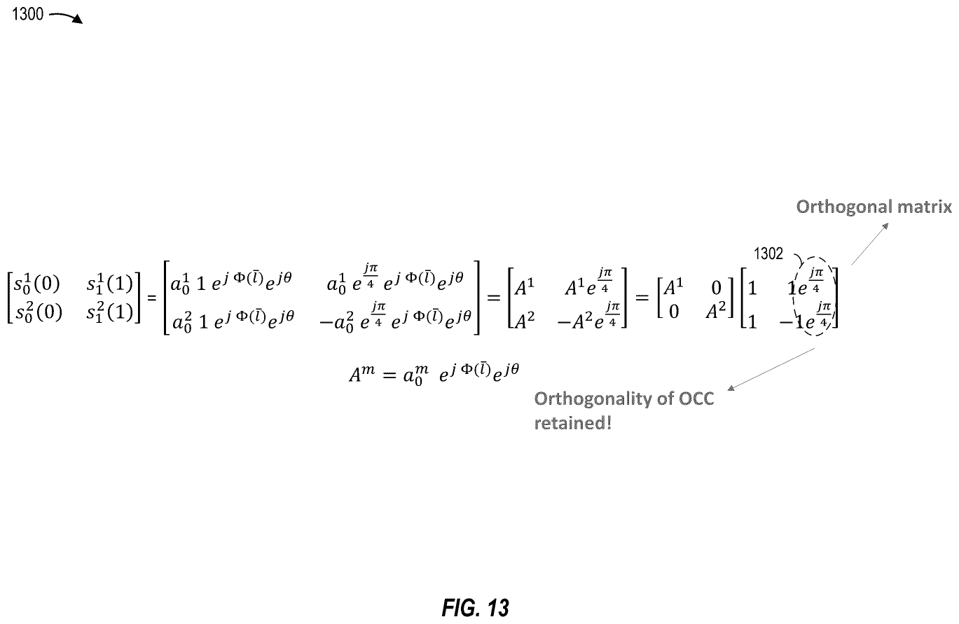

Taking this result, the baseband signals at both UEs can be written as a matrix, as illustrated in diagram 1300 of FIG. 13. Because of the same phase rotation factors used by each UE,

$${e}^{\frac{j π}{4}} ,$$

as indicated at 1302, an orthogonal matrix results and orthogonality of OCC is maintained.

As demonstrated, by making phase rotations same for both modulation schemes (QPSK and BPSK) in baseband signal generation, UEs using different modulation schemes may be multiplexed together. Hence, the techniques proposed herein may help provide flexible multiplexing of UEs independent of the modulation scheme. The techniques may be used, for example, to provide flexibility for NBIoT NTN systems using NPUSCH with OCC.

Variations of such a rule described above may also be used. In some cases, the variations may apply to certain OCC entities (e.g., symbol v. slot) or subcarrier spacings. For example, for symbol-level OCC (e.g., for 3.75 kHz SCS), the conventional phase rotations may be used and the network may try and ensure that UEs with the same modulation schemes are grouped together in an OCC group. However, for slot-level OCC (e.g., for 15 kHz SCS) the phase rotation may be based on OCC (e.g., the phase rotation factor ρ for BPSK and/or QPSK may depend on whether or not OCC is enabled as in the example above).

There may also be various scenarios where phase rotation is introduced for symbol-level OCC and not for slot-level OCC (and the network may group UEs with the same modulation schemes together). In general, there may be scenarios where rotation may depend on the unit (entity) on which OCC is performed (e.g., whether it is symbol-level OCC or slot-level OCC).

According to a second option, aspects of the present disclosure may rotate elements of the OCC codeword based on the modulation scheme. According to this option, the baseband signal generation may remain essentially the same. However, some form of rotation may be introduced in some part (e.g., the first or second element) of the OCC CWs.

In some cases, when grouping UEs together, a network entity (e.g., gNB) may know which multiplexed UEs will use BPSK and which UEs will use QPSK.

According to certain aspects, the network entity may provide signaling to (one or more of) the UEs that indicates they should rotate parts of OCC codewords. Such rotation may help neutralize the difference in phase rotation caused by baseband signal generation. The signaling providing the indication may be, for example, downlink control information (DCI) or radio resource control (RRC) signaling.

In such cases, the network entity may indicate to the UEs to perform codeword (CW) phase rotation. For example, the network may tell one of the UEs to rotate the 2^{nd} element of OCC CW that the UE has to transmit. This indication may be provided dynamically in DCI or semi-statically in RRC. In any case, the UE may introduce the rotation indicated by the network entity.

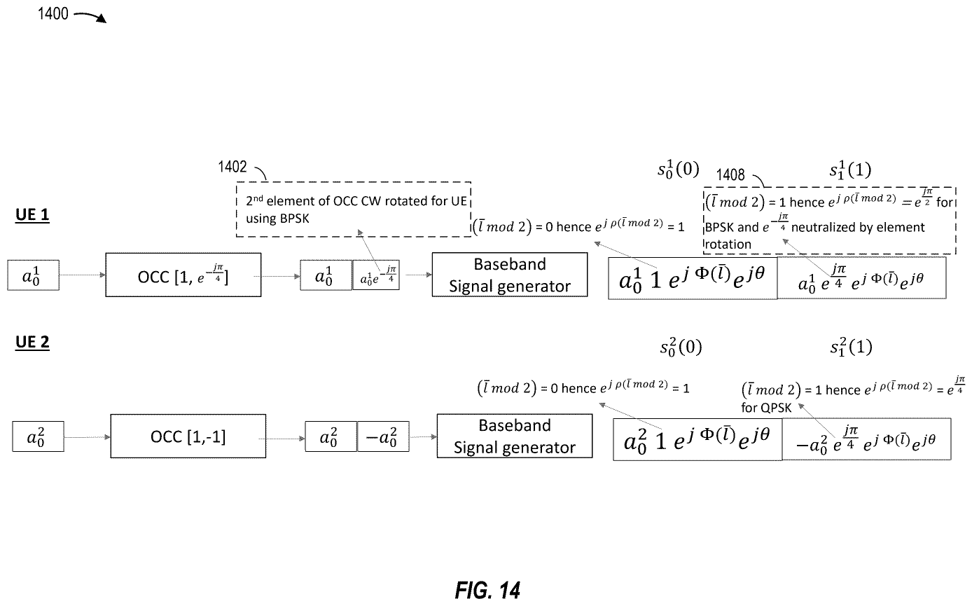

Operation of this second option may be understood by considering diagram 1400 shown in FIG. 14, which depicts an example of baseband signal generation with OCC. In the illustrated example, UE1 uses BPSK, and UE2 uses QPSK.

As illustrated at 1402, in this example, one of the UEs (UE1 using BPSK in the example) applies a rotation

$$( {e}^{- \frac{j π}{4}} )$$

to the second element of the OCC CW.

As illustrated, the first element of each UE may be the same. As noted at 1408, for UE1:

$$( \overline{l} mod 2 ) = 1 hence {e}^{j ρ ( \overline{l} mod 2 )} = {e}^{\frac{j π}{2}} for BPSK , and {e}^{- \frac{j π}{4}}$$

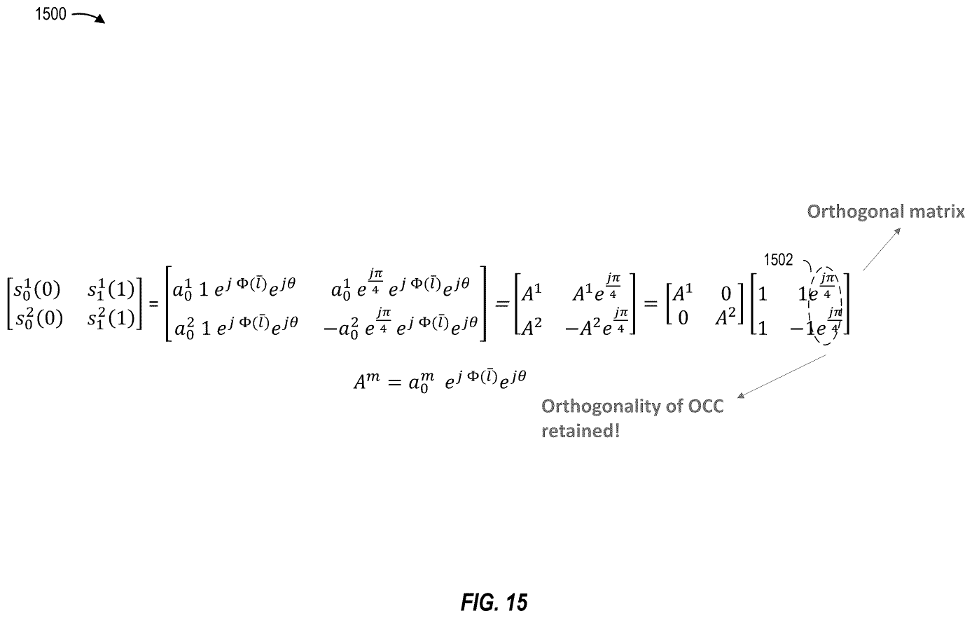

neutralized by the element rotation indicated at 1402. Taking this result, with the new phase rotation applied at UE1, the baseband signals at both UEs can be written as a matrix, as illustrated in diagram 1500 of FIG. 15. Because of the same phase rotation factors used by each UE,

$${e}^{\frac{j π}{4}} ,$$

as indicated at 1502, an orthogonal matrix results and orthogonality of OCC is maintained.

Thus, by rotating certain elements of an OCC CW in this manner, the orthogonality during the baseband signal generation of NPUSCH OCC can be retained, even when UEs are using different modulation schemes. As a result, this second option may also provide flexibility in allowing the multiplexing of UEs, independent of the modulation scheme. This flexibility may be beneficial in various use cases, such as in NBIoT NTN systems using NPUSCH with OCC.

There are various options for exactly how the rotation applied to an OCC CW is indicated. As an example, a network entity may indicate the rotation of elements explicitly for every symbol. As another example, the network entity may indicate a rotation sequence. In such cases, the sequences may be fixed (e.g., defined in a standard specification) or may be configured (e.g., via RRC signaling).

According to certain aspects, certain signaling may be introduced to indicate a UE's and/or network entity's capability to support the techniques proposed herein.

For example, a UE may provide signaling that informs the network that the UE can support the multiplexing techniques proposed herein. In some cases, this capability for supporting multiplexing may depend on the phase coherence capabilities associated with the UE.

In some cases, a network entity may configure a UE (e.g., via RRC) with UE specific details for NPUSCH transmissions with OCC. In such cases, the network entity may inform the UE about the OCC configuration (e.g., OCC/spread factor M+the particular OCC CW assigned to the UE). Further, the network entity may inform the UE (or UEs) about how to rotate elements of OCC CW if applicable (e.g., according to the second option described above). After receiving the signaling, the UE may follow the proposed procedures for transmitting NPUSCH with OCC, as indicated.

### Example Operations

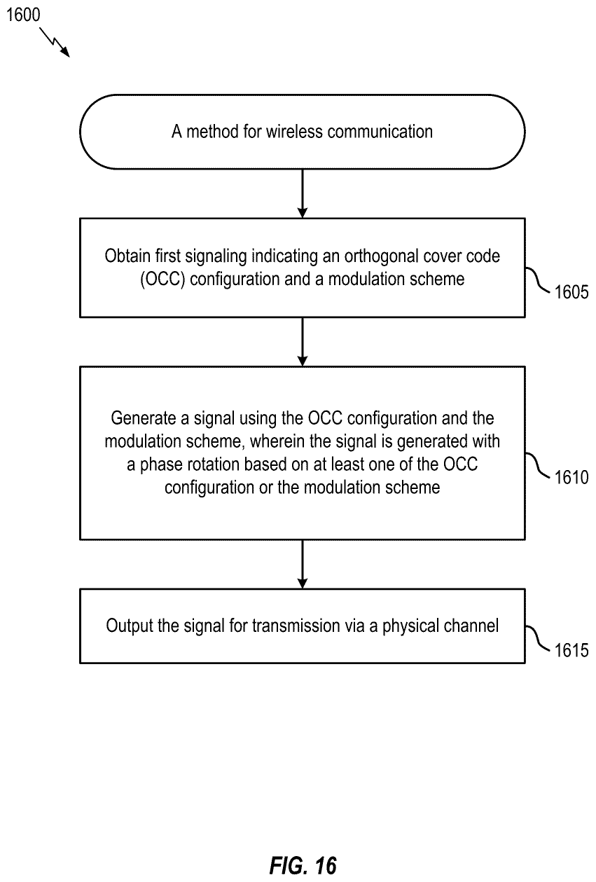

FIG. 16 shows an example of a method 1600 of wireless communication at a wireless node, such as a UE 104 of FIGS. 1 and 3.

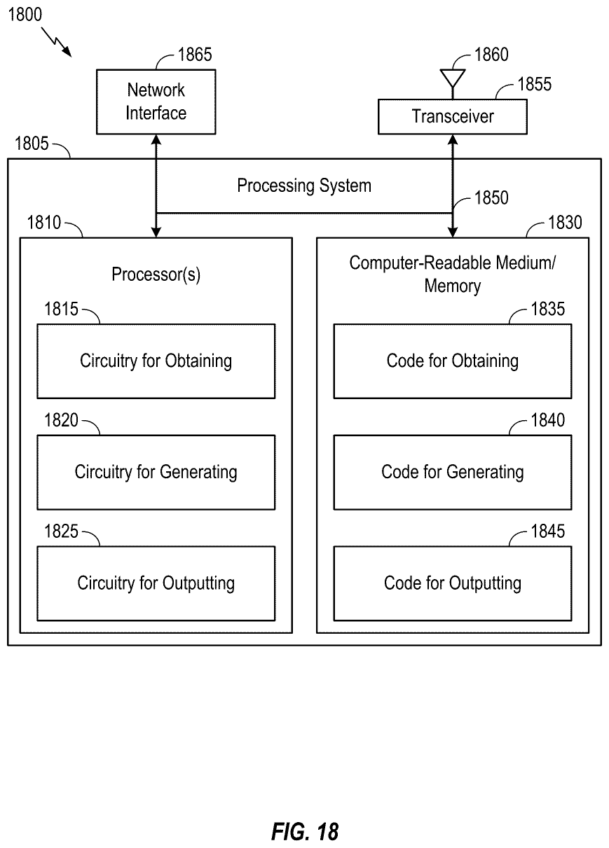

Method 1600 begins at step 1605 with obtaining first signaling indicating an orthogonal cover code (OCC) configuration and a modulation scheme. In some cases, the operations of this step refer to, or may be performed by, circuitry for obtaining and/or code for obtaining as described with reference to FIG. 18.

Method 1600 then proceeds to step 1610 with generating a signal using the OCC configuration and the modulation scheme, wherein the signal is generated with a phase rotation based on at least one of the OCC configuration or the modulation scheme. In some cases, the operations of this step refer to, or may be performed by, circuitry for generating and/or code for generating as described with reference to FIG. 18.

Method 1600 then proceeds to step 1615 with outputting the signal for transmission via a physical channel. In some cases, the operations of this step refer to, or may be performed by, circuitry for outputting and/or code for outputting as described with reference to FIG. 18.

In some aspects, the physical channel comprises a narrowband physical uplink shared channel (NPUSCH).

In some aspects, the phase rotation is independent of the modulation scheme when the OCC configuration enables OCC.

In some aspects, the phase rotation depends on the modulation scheme when OCC based signal generation is disabled.

In some aspects, the phase rotation depends on a unit over which OCC is performed when generating the signal.

In some aspects, at least one of: the OCC configuration specifies an OCC codeword, the phase rotation is accomplished by rotating at least one element of the OCC codeword, or the method further comprises obtaining second signaling indicating to rotate the at least one element of the OCC codeword.

In some aspects, the second signaling further indicates how much to rotate the at least one element.

In some aspects, the second signaling comprises at least one of downlink control information (DCI) or radio resource control (RRC) signaling.

In some aspects, the method 1600 further includes outputting signaling indicating a capability for generating a signal by using OCC with phase rotation. In some cases, the operations of this step refer to, or may be performed by, circuitry for outputting and/or code for outputting as described with reference to FIG. 18.

In one aspect, method 1600, or any aspect related to it, may be performed by an apparatus, such as communications device 1800 of FIG. 18, which includes various components operable, configured, or adapted to perform the method 1600. Communications device 1800 is described below in further detail.

Note that FIG. 16 is just one example of a method, and other methods including fewer, additional, or alternative steps are possible consistent with this disclosure.

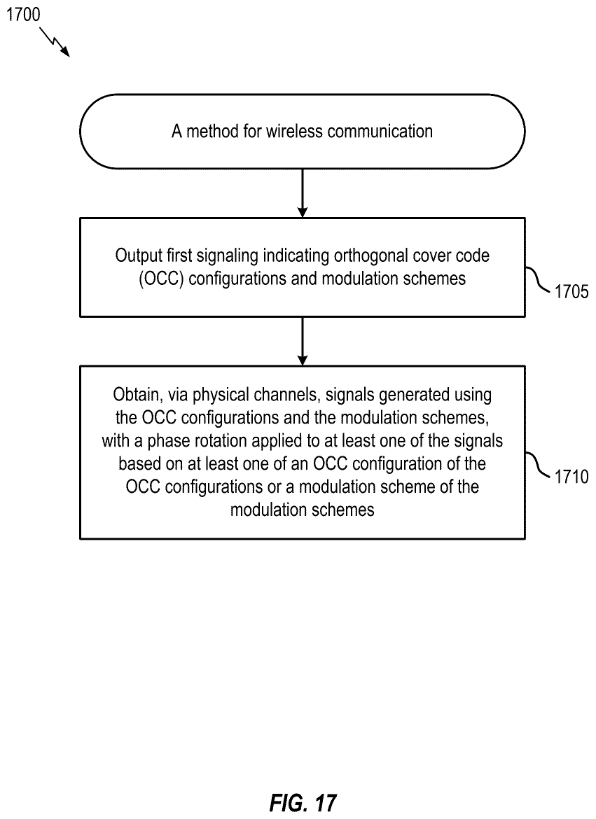

FIG. 17 shows an example of a method 1700 of wireless communication at a wireless node, such as a BS 102 of FIGS. 1 and 3, or a disaggregated base station as discussed with respect to FIG. 2.

Method 1700 begins at step 1705 with outputting first signaling indicating orthogonal cover code (OCC) configurations and modulation schemes. In some cases, the operations of this step refer to, or may be performed by, circuitry for outputting and/or code for outputting as described with reference to FIG. 18.

Method 1700 then proceeds to step 1710 with obtaining, via physical channels, signals generated using the OCC configurations and the modulation schemes, with a phase rotation applied to at least one of the signals based on at least one of an OCC configuration of the OCC configurations or a modulation scheme of the modulation schemes. In some cases, the operations of this step refer to, or may be performed by, circuitry for obtaining and/or code for obtaining as described with reference to FIG. 18.

In some aspects, the physical channel comprises a narrowband physical uplink shared channel (NPUSCH).

In some aspects, the phase rotation is independent of the modulation scheme when the OCC configuration enables OCC.

In some aspects, the phase rotation depends on the modulation scheme when OCC based signal generation is disabled.

In some aspects, the phase rotation depends on a unit over which OCC is performed when generating the signal.

In some aspects, at least one of: the OCC configuration specifies an OCC codeword, the phase rotation is accomplished by rotating at least one element of the OCC codeword, or the method further comprises outputting second signaling indicating a wireless node to rotate the at least one element of the OCC codeword.

In some aspects, the second signaling further indicates how much to rotate the at least one element.

In some aspects, the second signaling comprises at least one of downlink control information (DCI) or radio resource control (RRC) signaling.

In some aspects, the method 1700 further includes obtaining signaling indicating that a wireless node is capable of generating a signal by using OCC with phase rotation. In some cases, the operations of this step refer to, or may be performed by, circuitry for obtaining and/or code for obtaining as described with reference to FIG. 18.

In one aspect, method 1700, or any aspect related to it, may be performed by an apparatus, such as communications device 1800 of FIG. 18, which includes various components operable, configured, or adapted to perform the method 1700. Communications device 1800 is described below in further detail.

Note that FIG. 17 is just one example of a method, and other methods including fewer, additional, or alternative steps are possible consistent with this disclosure.

### Example Communications Device(s)

FIG. 18 depicts aspects of an example communications device 1800. In some aspects, communications device 1800 is a user equipment, such as UE 104 described above with respect to FIGS. 1 and 3. In some aspects, communications device 1800 is a network entity, such as BS 102 of FIGS. 1 and 3, or a disaggregated base station as discussed with respect to FIG. 2.

The communications device 1800 includes a processing system 1805 coupled to the transceiver 1855 (e.g., a transmitter and/or a receiver). In some aspects (e.g., when communications device 1800 is a network entity), processing system 1805 may be coupled to a network interface 1865 that is configured to obtain and send signals for the communications device 1800 via communication link(s), such as a backhaul link, midhaul link, and/or fronthaul link as described herein, such as with respect to FIG. 2. The transceiver 1855 is configured to transmit and receive signals for the communications device 1800 via the antenna 1860, such as the various signals as described herein. The processing system 1805 may be configured to perform processing functions for the communications device 1800, including processing signals received and/or to be transmitted by the communications device 1800.

The processing system 1805 includes one or more processors 1810. In various aspects, the one or more processors 1810 may be representative of one or more of receive processor 358, transmit processor 364, TX MIMO processor 366, and/or controller/processor 380, as described with respect to FIG. 3. In various aspects, one or more processors 1810 may be representative of one or more of receive processor 338, transmit processor 320, TX MIMO processor 330, and/or controller/processor 340, as described with respect to FIG. 3. The one or more processors 1810 are coupled to a computer-readable medium/memory 1830 via a bus 1850. In certain aspects, the computer-readable medium/memory 1830 is configured to store instructions (e.g., computer-executable code) that when executed by the one or more processors 1810, cause the one or more processors 1810 to perform the method 1600 described with respect to FIG. 16, or any aspect related to it; and the method 1700 described with respect to FIG. 17, or any aspect related to it. Note that reference to a processor performing a function of communications device 1800 may include one or more processors 1810 performing that function of communications device 1800.

In the depicted example, computer-readable medium/memory 1830 stores code (e.g., executable instructions), such as code for obtaining 1835, code for generating 1840, and code for outputting 1845. Processing of the code for obtaining 1835, code for generating 1840, and code for outputting 1845 may cause the communications device 1800 to perform the method 1600 described with respect to FIG. 16, or any aspect related to it; and the method 1700 described with respect to FIG. 17, or any aspect related to it.

The one or more processors 1810 include circuitry configured to implement (e.g., execute) the code stored in the computer-readable medium/memory 1830, including circuitry for obtaining 1815, circuitry for generating 1820, and circuitry for outputting 1825. Processing with circuitry for obtaining 1815, circuitry for generating 1820, and circuitry for outputting 1825 may cause the communications device 1800 to perform the method 1600 described with respect to FIG. 16, or any aspect related to it; and the method 1700 described with respect to FIG. 17, or any aspect related to it.

Various components of the communications device 1800 may provide means for performing the method 1600 described with respect to FIG. 16, or any aspect related to it; and the method 1700 described with respect to FIG. 17, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1855 and the antenna 1860 of the communications device 1800 in FIG. 18. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1855 and the antenna 1860 of the communications device 1800 in FIG. 18.

### Example Clauses

Implementation examples are described in the following numbered clauses:

Clause 1: A method for wireless communication at a wireless node, comprising: obtaining first signaling indicating an orthogonal cover code (OCC) configuration and a modulation scheme; generating a signal using the OCC configuration and the modulation scheme, wherein the signal is generated with a phase rotation based on at least one of the OCC configuration or the modulation scheme; and outputting the signal for transmission via a physical channel.

Clause 2: The method of Clause 1, wherein the physical channel comprises a narrowband physical uplink shared channel (NPUSCH).

Clause 3: The method of any one of Clauses 1-2, wherein, the phase rotation is independent of the modulation scheme when the OCC configuration enables OCC.

Clause 4: The method of Clause 3, wherein the phase rotation depends on the modulation scheme when OCC based signal generation is disabled.

Clause 5: The method of any one of Clauses 1-4, wherein the phase rotation depends on a unit over which OCC is performed when generating the signal.

Clause 6: The method of any one of Clauses 1-5, wherein at least one of: the OCC configuration specifies an OCC codeword, the phase rotation is accomplished by rotating at least one element of the OCC codeword, or the method further comprises obtaining second signaling indicating to rotate the at least one element of the OCC codeword.

Clause 7: The method of Clause 6, wherein the second signaling further indicates how much to rotate the at least one element.

Clause 8: The method of Clause 6, wherein the second signaling comprises at least one of downlink control information (DCI) or radio resource control (RRC) signaling.

Clause 9: The method of any one of Clauses 1-8, further comprising outputting signaling indicating a capability for generating a signal by using OCC with phase rotation.

Clause 10: A method for wireless communication at a wireless node, comprising: outputting first signaling indicating orthogonal cover code (OCC) configurations and modulation schemes; and obtaining, via physical channels, signals generated using the OCC configurations and the modulation schemes, with a phase rotation applied to at least one of the signals based on at least one of an OCC configuration of the OCC configurations or a modulation scheme of the modulation schemes.

Clause 11: The method of Clause 10, wherein the physical channel comprises a narrowband physical uplink shared channel (NPUSCH).

Clause 12: The method of any one of Clauses 10-11, wherein, the phase rotation is independent of the modulation scheme when the OCC configuration enables OCC.

Clause 13: The method of Clause 12, wherein the phase rotation depends on the modulation scheme when OCC based signal generation is disabled.

Clause 14: The method of any one of Clauses 10-13, wherein the phase rotation depends on a unit over which OCC is performed when generating the signal.

Clause 15: The method of any one of Clauses 10-14, wherein at least one of: the OCC configuration specifies an OCC codeword, the phase rotation is accomplished by rotating at least one element of the OCC codeword, or the method further comprises outputting second signaling indicating a wireless node to rotate the at least one element of the OCC codeword.

Clause 16: The method of Clause 15, wherein the second signaling further indicates how much to rotate the at least one element.

Clause 17: The method of Clause 15, wherein the second signaling comprises at least one of downlink control information (DCI) or radio resource control (RRC) signaling.

Clause 18: The method of any one of Clauses 10-17, further comprising obtaining signaling indicating that a wireless node is capable of generating a signal by using OCC with phase rotation.

Clause 19: An apparatus, comprising: at least one memory comprising executable instructions; and at least one processor configured to execute the executable instructions and cause the apparatus to perform a method in accordance with any combination of Clauses 1-18.

Clause 20: An apparatus, comprising means for performing a method in accordance with any combination of Clauses 1-18.

Clause 21: A non-transitory computer-readable medium comprising executable instructions that, when executed by at least one processor of an apparatus, cause the apparatus to perform a method in accordance with any combination of Clauses 1-18.

Clause 22: A computer program product embodied on a computer-readable storage medium comprising code for performing a method in accordance with any combination of Clauses 1-18.

Clause 23: A wireless node (e.g., a UE), including: at least one transceiver, at least one memory including instructions; and at least one processor configured to execute the instructions to cause the apparatus to perform a method in accordance with any combination of Clauses 1-9, wherein the at least one transceiver is configured to receive the first signaling.

Clause 24: A wireless node (e.g., a network entity), including: at least one transceiver, at least one memory including instructions; and at least one processor configured to execute the instructions to cause the apparatus to perform a method in accordance with any combination of Clauses 10-18, wherein the at least one transceiver is configured to transmit the first signaling.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

Means for obtaining, means for generating, and means for outputting may comprise one or more processors, such as one or more of the processors described above with reference to FIG. 18.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication, comprising:
at least one memory comprising instructions; and
one or more processors configured to execute the instructions to cause the apparatus to:
obtain first signaling indicating an orthogonal cover code (OCC) configuration and a modulation scheme;
generate a signal using the OCC configuration and the modulation scheme, wherein the signal is generated with a phase rotation based on at least one of the OCC configuration or the modulation scheme; and
output the signal for transmission via a physical channel.

2. The apparatus of claim 1, wherein the physical channel comprises a narrowband physical uplink shared channel (NPUSCH).

3. The apparatus of claim 1, wherein, the phase rotation is independent of the modulation scheme when the OCC configuration enables OCC.

4. The apparatus of claim 3, wherein the phase rotation depends on the modulation scheme when OCC based signal generation is disabled.

5. The apparatus of claim 1, wherein the phase rotation depends on a unit over which OCC is performed when generating the signal.

6. The apparatus of claim 1, wherein at least one of:
the OCC configuration specifies an OCC codeword,
the phase rotation is accomplished by rotating at least one element of the OCC codeword, or
the one or more processors are further configured to execute the instructions to cause the apparatus to obtain second signaling indicating the apparatus is to rotate the at least one element of the OCC codeword.

7. The apparatus of claim 6, wherein the second signaling further indicates how much to rotate the at least one element.

8. The apparatus of claim 6, wherein the second signaling comprises at least one of downlink control information (DCI) or radio resource control (RRC) signaling.

9. The apparatus of claim 1, wherein the one or more processors are further configured to execute the instructions to cause the apparatus to output signaling indicating the apparatus is capable of generating a signal by using OCC with phase rotation.

10. The apparatus of claim 1, further comprising at least one transceiver configured to receive the first signaling, wherein the apparatus is configured as a user equipment (UE).

11. An apparatus for wireless communication, comprising:
at least one memory comprising instructions; and
one or more processors configured to execute the instructions to cause the apparatus to:
output first signaling indicating orthogonal cover code (OCC) configurations and modulation schemes; and
obtain, via physical channels, signals generated using the OCC configurations and the modulation schemes, with a phase rotation applied to at least one of the signals based on at least one of an OCC configuration of the OCC configurations or a modulation scheme of the modulation schemes.

12. The apparatus of claim 11, wherein the physical channel comprises a narrowband physical uplink shared channel (NPUSCH).

13. The apparatus of claim 11, wherein the phase rotation:
is independent of the modulation scheme when the OCC configuration enables OCC, and
depends on the modulation scheme when OCC based signal generation is disabled.

14. The apparatus of claim 11, wherein the phase rotation depends on a unit over which OCC is performed when generating the signal.

15. The apparatus of claim 11, wherein at least one of:
the OCC configuration specifies an OCC codeword,
the phase rotation is accomplished by rotating at least one element of the OCC codeword, or
the one or more processors are further configured to execute the instructions to cause the apparatus to output second signaling indicating a wireless node to rotate the at least one element of the OCC codeword.

16. The apparatus of claim 15, wherein the second signaling further indicates how much to rotate the at least one element.

17. The apparatus of claim 15, wherein the second signaling comprises at least one of downlink control information (DCI) or radio resource control (RRC) signaling.

18. The apparatus of claim 11, wherein the one or more processors are further configured to execute the instructions to cause the apparatus to obtain signaling indicating that a wireless node is capable of generating a signal by using OCC with phase rotation.

19. The apparatus of claim 11, further comprising at least one transceiver configured to transmit the first signaling, wherein the apparatus is configured as a network entity.

20. A method for wireless communication by a wireless node, comprising:
receiving first signaling indicating an orthogonal cover code (OCC) configuration and a modulation scheme;
generating a signal using the OCC configuration and the modulation scheme, wherein the signal is generated with a phase rotation based on at least one of the OCC configuration or the modulation scheme; and
transmitting the signal for transmission via a physical channel.
